(19) United States
(12) Patent Application Publication
(10) Pub. No.: US 2002/0129152 A1
(43) Pub. Date: Sep. 12, 2002

(54) Protecting contents of computer data files from suspected intruders by programmed file destruction

(75) Inventors: Gerald Francis McBrearty, Austin, TX (US); Shawn Patrick Mullen, Buda, TX (US); Johnny Meng-Han Shieh, Austin, TX (US); Michael William Wortman, Cedar Park, TX (US)

Correspondence Address: International Business Machines Corporation, Intellectual Property Law Department, Internal Zip 4054, 11400 Burnet Road, Austin, TX, 78758, US

(73) Assignee: International Business Machines Corporation, Armonk, NY (US)

(21) Appl. No.: 09/801,614

(22) Filed: Mar. 8, 2001

(51) Int. Cl. G06F 15/173; G06F 15/16

(52) U.S. Cl. 709/229; 709/225

(57) ABSTRACT

Data files are protected from being stolen or compromised by unauthorized users by a system comprising receiving user requests for access to data files, means for whether said requests are unauthorized and means for destroying the requested data files responsive to a determination that a request is unauthorized for such files. The present invention offers a very aggressive solution to the problem of theft of data in files. At the first suspicion of intrusion, there is a set up for destroying the intruded files. It would be advantageous to have duplicate or backup files for all files. These duplicates must be substantially inaccessible to user requests.

### CROSS-REFERENCE TO RELATED PATENT APPLICATION:

The following copending patent application, assigned to the assignee of the present invention, covers subject matter related to the subject matter of the present patent application: PROTECTING CONTENTS OF COMPUTER DATA FILES FROM SUSPECTED INTRUDERS BY RENAMING AND HIDING DATA FILES SUBJECTED TO INTRUSION, Attorney Docket No. AUS9-2000-0941, SN ______, G. F. McBrearty et al., filed on the same date as the present Application.

### TECHNICAL FIELD

The present invention relates to the protection of files from unauthorized or suspected intrusion in computer systems, and particularly in managed communication networks such as the World Wide Web (Web).

### BACKGROUND OF RELATED ART

The past decade has been marked by a technological revolution driven by the convergence of the data processing industry with the consumer electronics industry. The effect has, in turn, driven technologies which have been known and available but relatively quiescent over the years. A major one of these technologies is the Internet or Web related distribution of documents, media and programs. The convergence of the electronic entertainment and consumer industries with data processing exponentially accelerated the demand for wide ranging communication distribution channels, and the Web or Internet (the terms are used interchangeably) commenced a period of phenomenal expansion. With this expansion, businesses and consumers have direct access to all matter of documents, media and computer programs.

In order for the Web to reach its full potential as the basic channel for all world wide business and academic transactions and communications, the providers and users of the Web, and like networks, must be assured an open communication environment, as well as protection of the data that is offered over the Web and the requests made for such data. With the rise of the Web, there has been an unfortunate increase in the number of malicious users who, at the least, try to disrupt Web and other network services and, at their worst, try to steal goods, services and data accessible over the Web. Of course, the industry has been working for many years to eliminate or, at least, neutralize the efforts of such malicious users.

Despite these security problems, the above factors have given rise to a new way of doing business, electronic business or E-business. This, of course, involves conducting all matter of business over the Web public networks and/or private networks when greater security is demanded. Electronic business requires the electronic handling and collection of cumulatively vast quantities of money. As a result, there are great quantities of records tracking transactions stored as files at various network nodes, as well as in individual computer systems. In order for electronic business to function, it is necessary to make quantities of these stored files available to a wide variety of users with various “needs to know” in order to handle various electronic business billing and other transactions. Thus, there are established levels of authorizations granted to users for accessing the contents of files. For example, a user may have authorization to make entries into files or copy files but not have authorization to read or access the contents of the files. Authorization levels are granted to users related to digital IDs assigned to such users. With the great sophistication in computer hacking of potential unauthorized intruders both within and on the outside of business organizations to access secure data, authorization is no longer just a simple comparison of user IDs to simple authorization lists and denying unauthorized requesters.

In addition, although electronic and Web business have vast potential, many consumers and business organizations are just beginners in that marketplace and are skeptical and uneasy about making their files accessible to others based upon network authorization. Thus, a significant compromise of data files or theft of data files could be disastrous to vendors trying to establish a sense of stability in that marketplace.

### SUMMARY OF THE PRESENT INVENTION

The present invention provides a system, method and program for protecting data files from being stolen or compromised. Accordingly, the invention provides in a data processing operation having stored data in a plurality of data files, a system for protecting said data files from unauthorized users comprising means for receiving user requests for access to data files, means for determining whether said requests are unauthorized intrusions into the requested data files and means responsive to a determination that a request is unauthorized for destroying the requested data files. The present invention offers a very aggressive solution to the problem of theft of data in files. At the first suspicion of intrusion, there is a set up for destroying the intruded files. It would be advantageous to have duplicate or backup files for all files. These must be substantially inaccessible to user requests.

In some systems, the data files may be so sensitive that the system may be programmed to have the requested files destroyed at the first unauthorized request for access to the file contents or at the second consecutive unauthorized request. However, dependent on the system needs, various patterns of user behavior may be monitored and used to trigger a conclusion that there has been an intrusion based upon an unauthorized request. For example, for various file handling purposes, certain users are given lower level authorizations to copy data files without giving such users higher level authorizations to access the contents of the files that they are authorized to copy. However, it may be potentially feasible that some authorized user who has copied files then tries to decode the user authorization to access such copied files. To protect against such a possible intrusion, the system may be programmed so that after every access to copy a set of data files, the files are then tracked for any relatively immediate unauthorized request for access to contents. The events being tracked have been simplified for proposes of illustration. However, dependent on the data file system being tracked, various combinations of user requests or actions may be predetermined to raise the suspicion that there has been an unauthorized intrusion into the data file and the destruction of the files is carried out as aggressive damage control.

While the present invention satisfies present needs in network and particularly Web file protection, the principles of the invention are equally applicable to stored data files associated with independent computer systems.

### BRIEF DESCRIPTION OF THE DRAWINGS

The present invention will be better understood and its numerous objects and advantages will become more apparent to those skilled in the art by reference to the following drawings, in conjunction with the accompanying specification, in which:

FIG. 1 is a generalized diagrammatic view of a Web portion showing how open Web sites may be accessed by and protected from unauthorized and malicious requesting users;

FIG. 2 is a block diagram of a data processing system including a central processing unit and network connections via a communications adapter which is capable of functioning both as a display computer for controlling Web stations and sites and as the servers for monitoring user request patterns to determine unauthorized access or intrusion;

FIG. 3 is an illustrative flowchart describing the setting up of the elements of a program according to the present invention for protecting Web stations, as well as computer systems from malicious requesting users; and

FIG. 4 is a flowchart of an illustrative run of the program set up in FIG. 3.

### DETAILED DESCRIPTION OF THE PREFERRED EMBODIMENT

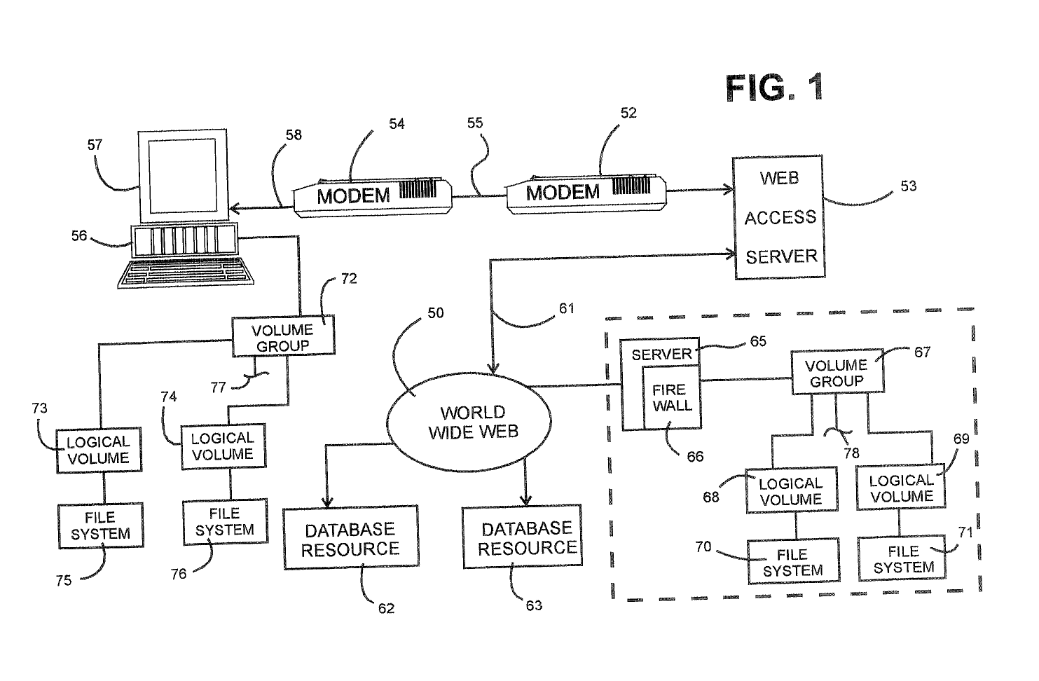

Referring to FIG. 1, there is provided a generalized view of a network, such as the Web or Internet (used interchangeably herein), showing illustrative Web sites as resource databases 62, 63 and 64. The latter database 64 is shown in greater detail within its dashed line boundary. The database is made up of one or more volume groups 67 which is shown connected to logical volume 68 including file system 70, logical volume 69 including file system 71, as well as cut connection 78 which represents potential connections to other logical volumes and file systems. Thus, files requested by users at stations such as station 57 including computer 56 throughout the Web 50 are processed to the particular database through the database server, such as server 65. Each server has the means for processing such requests, determining user authorizations for particular data file access and handling levels to be hereinafter described. These authorization processes are illustratively shown to be encompassed within firewall section 66.

The computer 56, which serves as the-Web station 57, has its own associated database made up of one or more volume groups 72 which is shown connected to logical volume 73 including file system 75, logical volume 74 including file system 76, as well as cut connection 77 which represents potential connections to other logical volumes and file systems. This volume group 72 may be directly accessed by the user of computer 56 as a standalone computer irrespective of its Web connections. Thus, when the routines for determining user authorization at various database access and handling levels and the consequential destruction of files are hereinafter described, it will be understood that such routines may be performed to check authorization as a Web data access function in the server 65 or as routines performed within the computer 56 system to check on user requests made directly to computer 56.

By way of background and for details on Web nodes, objects and links, reference is made to the text, Mastering the Internet, G. H. Cady et al., published by Sybex Inc., Alameda, Calif., 1996; or the text, Internet: The Complete Reference, Millennium Edition, Margaret Young et al., Osborne/McGraw-Hill, Berkeley, Calif., 1999. Any data communication system which interconnects or links computer controlled systems with various sites defines a communications network. Of course the Internet or Web is a global network of a heterogeneous mix of computer technologies and operating systems. Higher level objects are linked to the lower level objects in the hierarchy through a variety of network server computers.

Reference may be made to the above-mentioned Mastering the Internet, pp. 136-147, for typical connections between local display stations to the Web via network servers; any of which may be used to implement the system on which this invention is used. The system embodiment of FIG. 1 has a host-dial connection. Such host-dial connections have been in use for over 30 years through network access servers 53 which are linked 61 to the Web 50. The servers 53 may be maintained by a service provider to the client's display terminal 57. The host's server 53 is accessed by the user terminal 57 through a normal dial-up telephone linkage 58 via modem 54, telephone line 55 and modem 52. User requested files from the Web may be downloaded to display terminal 57 through Web access server 53 via the telephone line linkages from server 53, which may have accessed them from the Internet 50 via linkage 61.

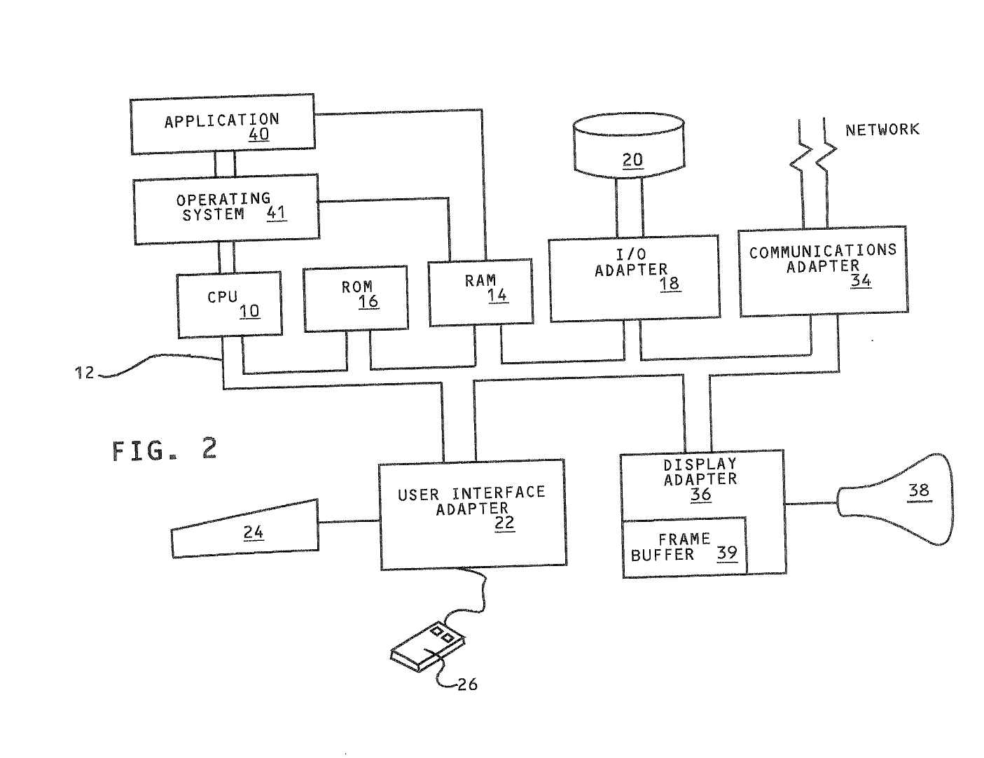

Referring to FIG. 2, a typical data processing terminal is shown which may function as the computer terminal for Web stations, e.g. terminal 57, FIG. 1, for requesting users or the servers which connect requesting user sites or Web sites into the Web. A central processing unit (CPU) 10, such as one of the PC microprocessors or workstations, e.g. RISC System/6000™ (RS/6000) series available from International Business Machines Corporation (IBM), is provided and interconnected to various other components by system bus 12. An operating system 41 runs on CPU 10, provides control and is used to coordinate the function of the various components of FIG. 2. Operating system 41 may be one of the commercially available operating systems such as the AIX 6000™ operating system available from IBM; Microsoft's Windows98™ or WindowsNT(™), as well as UNIX and AIX operating systems. Application programs 40, controlled by the system, are moved into and out of the main memory, Random Access Memory (RAM) 14. These programs include the programs of the present invention for the protection of open resource databases at their server and by the user for requesting data files directly from his computer system.

A Read Only Memory (ROM) 16 is connected to CPU 10 via bus 12 and includes the Basic Input/Output System (BIOS) that controls the basic computer functions. RAM 14, I/O adapter 18 and communications adapter 34 are also interconnected to system bus 12. I/O adapter 18 communicates with the disk storage device 20. Communications adapter 34 interconnects bus 12 with an outside network enabling the data processing system to communicate, as respectively described above, through the Web or Internet. I/O devices are also connected to system bus 12 via user interface adapter 22 and display adapter 36. Keyboard 24 and mouse 26 are all interconnected to bus 12 through user interface adapter 22. Display adapter 36 includes a frame buffer 39, which is a storage device that holds a representation of each pixel on the display screen 38. Images may be stored in frame buffer 39 for display on monitor 38 through various components, such as a digital to analog converter (not shown) and the like. By using the aforementioned I/O devices, a user is capable of inputting information to the system through the keyboard 24 or mouse 26 and receiving output information from the system via display 38.

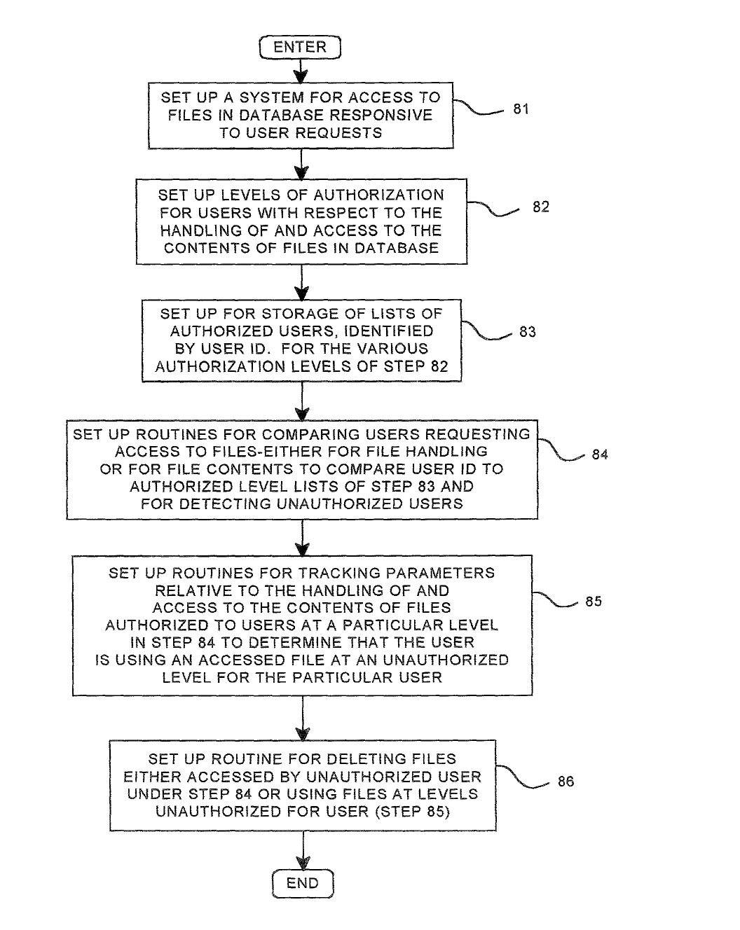

Now, with reference to programming shown in FIG. 3, the program of the present invention is set up. There is set up at the servers of the databases accessible through the Web and/or at individual computer systems, a system to access files in a database responsive to user requests, step 81. Levels of authorization are set up for users relative to the handling and access to the contents of the files in the database, step 82. Some levels of authorization could be: authorization to access limited data from files but not protected data; authorization to copy files but not to read contents; authorization to make file entries but not to read; and authorization to have files printed but not to read. There is a set up, step 83, for the storage of lists of users who are authorized for the various levels described in step 82. Routines are set up for comparing users requesting access to files, either for file handling or for file contents, so as to compare user IDs to authorized level lists of step 83 and for detecting unauthorized users, step 84. Routines are set up for tracking parameters relative to the handling and access to the contents of files authorized to users at any particular level as set forth in step 84 so as to be able to determine whether a user is using a file that he obtained at a level which is unauthorized for the particular user, step 85. Finally, step 86, a routine is set up for deleting and, thus, destroying files either accessed by an unauthorized user under step 84 or using files at levels unauthorized for the user in step 85.

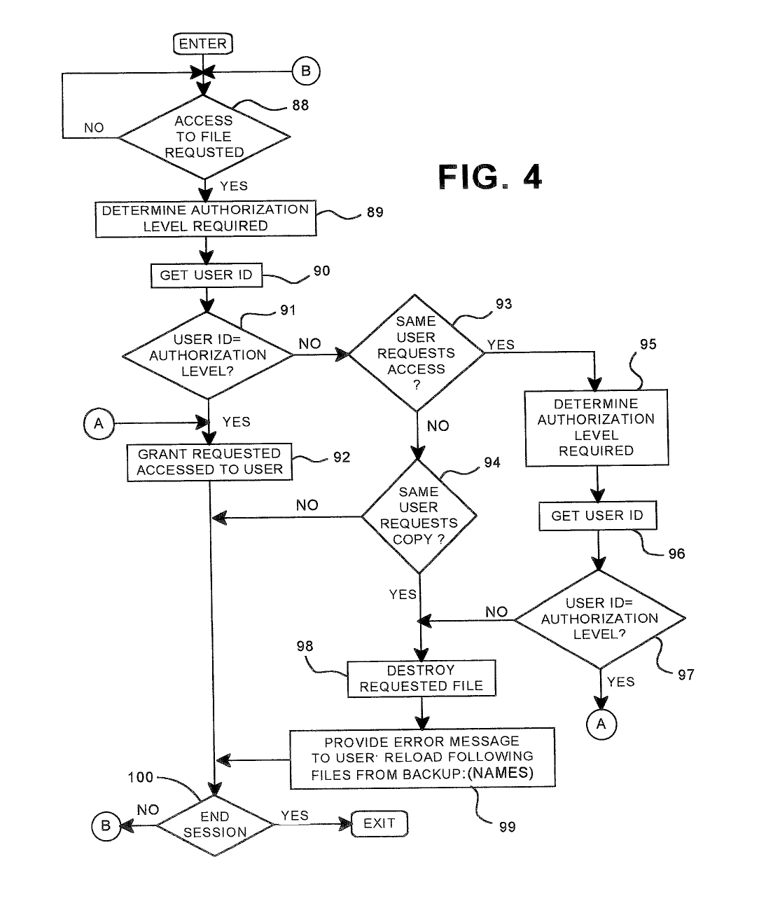

Now, with reference to the flowchart of FIG. 4, a simplified illustrative run of the process set up in FIG. 3 will be described. The simplification is made to illustrate a simple process. In considering this example, it should be understood that in many processes, the criteria for determining whether there has been unauthorized use may be more complex. However, the complexity of such a determination is not the point of the present invention. The key is how the files are treated once a determination of unauthorized access has been made. A determination is made, step 88, as to whether access to a file has been requested. If No, then the process is returned to step 88 and such a request is awaited. If Yes, then, step 89, a determination is made as to the authorization level required for access to the file and the user ID is obtained, step 90. Then step 91, a determination is made as to whether the user ID has the appropriate authorization level. If Yes, access to the file is granted, step 92. If No, then no authorization is given and an additional watch is made as to whether the same user subsequently again requests access to the same file, step 93. If Yes, then again a determination is made, step 95, as to the authorization level required for access to the file and the user ID is obtained, step 96. Then, step 97, a determination is made as to whether the user ID has the appropriate authorization level. If Yes, then the process is returned to step 92 via branch “A” where access to the file is granted. If, in step 97, a determination is made that the user ID does not have the appropriate authorization level, then the present process has been programmed to conclude that two consecutive ID failures gives rise to a suspicion of unauthorized access and the requested file is destroyed, step 98.

By similar steps, if the determination tracked in step 93, is No, a second access to the file has not been requested, then a further determination is made, step 94, as to whether the same user ID has requested copies or made copies of the originally requested files. In this aspect of the example, the present process has been programmed to conclude that the user may have a lower level authorization to copy. However, making a copy of a file after an ID failure at the higher access level has been programmed to also give rise to a suspicion of unauthorized access and a Yes determination at step 94 also causes the requested file to be destroyed, step 98.

There have been presented a few examples of how unauthorized intrusions may be determined. The technologies for coding and authenticating user requests for data files over the Internet provide for varieties of routines available for use in spotting or giving rise to the suspicion that there is an unauthorized intruder. For example, reference may be taken to MIT Kerberos V5, one of the later versions of such a cryptographic program publicly released by MIT, Cambridge Mass., May 1995.

After a file is destroyed in step 98, an error message is provided to the user to reload the following (destroyed) identified files from backup, step 99. The user, who has been maintaining periodically updated backup files, e.g. on CD-ROM or on disk, will then reload the backup files from such storage.

At this point, or after step 92 or a No determination from step 94, a determination may conveniently be made as to whether the session is ended, step 100. If Yes, the session is exited. If No, then the process is returned to step 88 via branch “B” and a new request for file access is awaited.

It should be noted that the programs covered by the present invention may be stored outside of the present computer systems until they are required. The program instructions may be stored in another readable medium, e.g. in a disk drive associated with the desktop computer or in a removable memory, such as an optical disk for use in a CD-ROM computer input or in a floppy disk for use in a floppy disk drive computer input. Further, the program instructions may be stored in the memory of another computer prior to use in the system of the present invention and transmitted over a network when required by the user of the present invention. One skilled in the art should appreciate that the processes controlling the present invention are capable of being distributed in the form of computer readable media of a variety of forms.

Although certain preferred embodiments have been shown and described, it will be understood that many changes and modifications may be made therein without departing from the scope and intent of the appended claims.

1. In a data processing operation having stored data in a plurality of data files, a system for protecting said data files from unauthorized users comprising:
means for receiving user requests for access to data files;
means for determining whether said requests are unauthorized intrusions into said requested data files; and
means responsive to a determination that a request is unauthorized for destroying the requested data files.

2. The data processing operation system of claim 1 further including means for storing for each of said plurality of data files, a backup file inaccessible to user requests.

3. The data processing operation system of claim 2 further including means for reloading a backup file for each destroyed file.

4. The data processing operation system of claim 1 wherein said means for determining whether said user requests are unauthorized intrusions include:
means for determining whether a user access identification code has been denied; and
means for determining whether the user has copied the requested files.

5. In a communication network with access to a plurality of network sites each having stored data in a plurality of data files accessible in response to requests from users at other sites in the network, a system for protecting said network site data files from unauthorized users comprising:
means associated with a network site for receiving user requests for access to data files;
means at said network site for determining whether said user requests are unauthorized intrusions into said requested data files; and
means at said network site responsive to a determination that a request is unauthorized for destroying the requested data files.

6. The communication network system of claim 5 further including means for storing for each of said plurality of data files at said network site, a backup file inaccessible to user requests.

7. In a World Wide Web communication network with access to a plurality of open Web sites each having stored data in a plurality of data files accessible in response to requests from users at stations throughout the Web, a system for protecting said open Web site data files from unauthorized users comprising:
means associated with an open Web site for receiving user requests for access to data files;
means at said open Web site for determining whether said user requests are unauthorized intrusions into said requested data files; and
means at said open Web site responsive to a determination that a request is unauthorized for destroying the requested data files.

8. The World Wide Web communication network system of claim 7 further including means for storing for each of said plurality of data files at said open Web site, a backup file inaccessible to user requests.

9. The World Wide Web communication network system of claim 8 further including means for reloading a backup file for each destroyed file.

10. In a data processing operation having stored data in a plurality of data files, a method for protecting said data files from unauthorized users comprising:
receiving user requests for access to data files;
determining whether said requests are unauthorized intrusions into said requested data files; and
destroying the requested data files responsive to a determination that a request is unauthorized.

11. The data processing method of claim 10 further including the step of storing for each of said plurality of data files, a backup file inaccessible to user requests.

12. The data processing method of claim 11 further including the step of reloading a backup file for each destroyed file.

13. The data processing method of claim 10 wherein said step of determining whether said user requests are unauthorized intrusions includes:
determining whether a user access identification code has been denied; and
determining whether the user has copied the requested files.

14. In a communication network with access to a plurality of network sites each having stored data in a plurality of data files accessible in response to requests from users at other sites in the network, a method for protecting said network site data files from unauthorized users comprising:
receiving user requests for access to data files at a network site;
determining at said network site whether said user requests are unauthorized intrusions into said requested data files; and
destroying the requested data files responsive to a determination that a request is unauthorized.

15. The communication network method of claim 14 further including the step of storing for each of said plurality of data files at said network site, a backup file inaccessible to user requests.

16. The communication network method of claim 15 further including the step of reloading a backup file for each destroyed file.

17. In a World Wide Web communication network with access to a plurality of open Web sites each having stored data in a plurality of data files accessible in response to requests from users at stations throughout the Web, a method for protecting said open Web site data files from unauthorized users comprising:
receiving user requests for access to data files at said open Web site;
determining whether said user requests are unauthorized intrusions into said requested data files at said open Web site; and
destroying the requested data files at said open Web site responsive to a determination that a request is unauthorized.

18. The World Wide Web communication network method of claim 17 further including the step of storing for each of said plurality of data files at said open Web site, a backup file inaccessible to user requests.

19. The World Wide Web communication network method of claim 18 further including the step of reloading a backup file for each destroyed file.

20. The World Wide Web communication network method of claim 17 wherein said step of determining whether said user requests are unauthorized intrusions includes:
determining whether a user access identification code has been denied; and
determining whether the user has copied the requested files.

21. A computer program having code recorded on a computer readable medium for protecting data files from unauthorized users in a data processing operation having stored data in a plurality of data files, said program comprising:
means for receiving user requests for access to data files;
means for determining whether said requests are unauthorized intrusions into said requested data files; and
means responsive to a determination that a request is unauthorized for destroying the requested data files.

22. The computer program of claim 21 further including means for storing for each of said plurality of data files, a backup file inaccessible to user requests.

23. The computer program of claim 22 further including means for reloading a backup file for each destroyed file.

24. The computer program of claim 21 wherein said means for determining whether said user requests are unauthorized intrusions include:
means for determining whether a user access identification code has been denied; and
means for determining whether the user has copied the requested files.

25. A computer program having code recorded on a computer readable medium for protecting data files from unauthorized users in a communication network with access to a plurality of network sites each having stored data in a plurality of data files accessible in response to requests from users at other sites in the network, said program comprising:
means associated with a network site for receiving user requests for access to data files;
means at said network site for determining whether said user requests are unauthorized intrusions into said requested data files; and
means at said network site responsive to a determination that a request is unauthorized for destroying the requested data files.

26. The computer program of claim 25 further including means for storing for each of said plurality of data files at said network site, a backup file inaccessible to user requests,

27. A computer program having code recorded on a computer readable medium for protecting open Web sites in a World Wide Web communication network with access to a plurality of open Web sites each having stored data in a plurality of data files accessible in response to requests from users at stations throughout the Web, said program comprising:
means associated with an open Web site for receiving user requests for access to data files;
means at said open Web site for determining whether said user requests are unauthorized intrusions into said requested data files; and
means at said open Web site responsive to a determination that a request is unauthorized for destroying the requested data files.

28. The computer program of claim 27 further including means for storing for each of said plurality of data files at said open Web site, a backup file inaccessible to user requests.

29. The computer program of claim 28 further including means for reloading a backup file for each destroyed file.

30. The computer program of claim 27 wherein said means for determining whether said user requests are unauthorized include:
means for determining whether a user access identification code has been denied; and
means for determining whether the user has copied the requested files.
